(19) United States
(12) Patent Application Publication
(10) Pub. No.: US 2008/0118859 A1
(43) Pub. Date: May 22, 2008

(54) Planographic Printing Plate Material and Planographic Printing Process

(76) Inventor: Hidetoshi Ezure, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/791,774

(22) PCT Filed: Nov. 17, 2005
(86) PCT No.: PCT/JP05/21078

§ 371 Date: May 29, 2007

(30) Foreign Application Priority Data
Dec. 3, 2004 (JP) 2004-350894

(51) Int. Cl. G03C 1/00

(52) U.S. Cl. 430/270.1

(57) ABSTRACT

The invention is to provide a planographic printing plate material providing excellent developability and printing durability and a planographic printing process employing the same, and particularly to provide a planographic printing plate material, which is capable of carrying out on-press development and provides excellent on-press development property and printing durability and a planographic printing process employing the same. The planographic printing plate material comprises a plastic support and provided thereon, a hydrophilic layer and an image formation layer, wherein the hydrophilic layer is a layer formed from an emulsion containing polymer particles with silica.

### FIELD OF THE INVENTION

The present invention relates to a planographic printing plate material comprising a plastic support, which is used in a computer to plate (CTP) system, and a planographic printing process employing the planographic printing plate material.

### PRIOR ART

In recent years, a computer to plate (CTP) system, in which digital image data can be directly recorded in a printing plate material, has been widely used accompanied with the digitization of printing data.

As a printing plate material usable for CTP, there are a printing plate material comprising an aluminum support such as a conventional PS plate, and a flexible printing plate material comprising a flexible resin film sheet and provided thereon, various functional layers.

Recently, in the commercial printing industries, there is a tendency that many kinds of prints are printed in a small amount, and an inexpensive printing plate material with high quality has been required in the market.

As a conventional flexible printing plate material, there are a silver salt diffusion transfer type printing plate material as disclosed in Japanese Patent O.P.I. Publication No. 5-66564, in which a silver salt diffusion transfer type light sensitive layer is provided on a flexible sheet; an ablation type printing plate material as disclosed in Japanese Patent O.P.I. Publication Nos. 8-507727, 6-186750, 6-199064, 7-314934, 10-58636 and 10-244773 in which a hydrophilic layer and a lipophilic layer, one of which is the outermost layer, are provided on a flexible sheet where the outermost layer is ablated by laser exposure to prepare a printing plate; and a heat melt type printing plate material as disclosed in Japanese Patent O.P.I. Publication No. 2001-96710 in which a hydrophilic layer and a heat melt image formation layer are provided on a flexible sheet where a hydrophilic layer or a heat melt image formation layer is imagewise heated by laser exposure to heat-fix the image formation layer onto the hydrophilic layer.

As an image formation method for printing, there is known a so-called on-press development from the environmental viewpoint, in which when a printing plate material after image writing (imagewise exposure) is mounted on an off-set press, and dampening water is supplied to the printing plate material during printing, only the image formation layer at non-image portions is swollen or dissolved by the dampening water, and transferred to a printing paper (paper waste) at initial printing, whereby the image formation layer at non-image portions is removed (see Patent Documents 1 and 2).

A printing plate material capable of being subjected to on-presensitized planographic printing plate development provides images with sharp dots and high precision, does not require a specific development after exposure, and is environmentally friendly.

However, this printing plate material has problems in that layer strength of the hydrophilic layer or image formation layer is low, and initial ink receptivity deteriorates, or on-press developing property or printing durability is insufficient. The above problems are serious particularly when printing is carried out employing a powdering system in order to prevent printing images from transferring to the rear surface of prints.

In order to solve the problems as described above, there is proposal in which a water-soluble resin or a thermoplastic resin is incorporated in a hydrophilic layer or an image formation layer (see Patent Document 3). However, the proposal is not sufficient to improve on-press developing property and printing durability as described above.

### (Patent Document 1)

### Japanese Patent O.P.I. Publication No. 9-123387

### (Patent Document 2)

### Japanese Patent O.P.I. Publication No. 9-123388

### (Patent Document 3)

### Japanese Patent O.P.I. Publication No. 2000-238451

### DISCLOSURE OF THE INVENTION

### Problems to be Solved by the Invention

An object of the invention is to provide a planographic printing plate material providing excellent developability and printing durability and a planographic printing process employing the same, and particularly to provide a planographic printing plate material, which is capable of carrying out on-press development and provides excellent on-press development property and printing durability and a planographic printing process employing the same.

### Means for Solving the Problems

The above object has been attained by the following constitution:

1. A planographic printing plate material comprising a plastic support and provided thereon, a hydrophilic layer and an image formation layer, wherein the hydrophilic layer is a layer formed from an emulsion containing polymer particles with silica.

2. A planographic printing plate material comprising a plastic support and provided thereon, a hydrophilic layer and an image formation layer, wherein the image formation layer is a layer formed from an emulsion containing polymer particles with silica.

3. The planographic printing plate material of item 1 above, wherein the hydrophilic layer contains polymer particles with silica.

4. The planographic printing plate material of item 2 above, wherein the image formation layer contains polymer particles with silica.

5. The planographic printing plate material of item 3 above, wherein the hydrophilic layer contains polymer particles with silica in an amount of 0.5 to 30% by weight.

6. The planographic printing plate material of item 4 above, wherein the image formation layer contains polymer particles with silica in an amount of 1 to 80% by weight.

7. The planographic printing plate material of any one of items 1 through 6 above, wherein the image formation layer is a thermosensitive image formation layer.

8. The planographic printing plate material of any one of items 1 through 7 above, wherein the hydrophilic layer or the image formation layer contains a light-to-heat conversion material.

9. The planographic printing plate material of any one of items 1 through 8 above, wherein the image formation layer is capable of being subjected to on-press development.

10. The planographic printing plate material of any one of items 1 through 9 above, wherein the planographic printing plate material is in the roll form.

11. A planographic printing process comprising the step of forming an image on the planographic printing plate material of item 9 or 10, employing a thermal head or a laser, developing the resulting planographic printing plate material on a planographic printing press by supplying dampening water or both of dampening water and printing ink onto the planographic printing plate material, and carrying out printing.

### EFFECTS OF THE INVENTION

The present invention is to provide a planographic printing plate material providing excellent developability and printing durability and a printing process employing the same, and particularly to provide a planographic printing plate material, which is capable of carrying out on-press development and provides excellent on-press development property and printing durability and a printing process employing the same.

### PREFERRED EMBODIMENT OF THE INVENTION

The present invention is a planographic printing plate material comprising a plastic support and provided thereon, a hydrophilic layer and an image formation layer, characterized in that the hydrophilic layer is a layer formed from an emulsion containing polymer particles with silica.

Further, the present invention is a planographic printing plate material comprising a plastic support and provided thereon, a hydrophilic layer and an image formation layer, characterized in that the image formation layer is a layer formed from an emulsion containing polymer particles with silica.

In the invention, the hydrophilic layer containing polymer particles with silica or the image formation layer containing polymer particles with silica provides a planographic printing plate material capable of being subjected to on-press development, and a planographic printing plate material having excellent on-press development property and excellent printing durability.

In the invention, a layer formed from an emulsion containing polymer particles with silica means one formed by coating a coating solution containing an emulsion containing polymer particles with silica on a support and drying it.

### (Emulsion Containing Polymer Particles with Silica)

The polymer particles with silica in the invention refers to thermoplastic polymer particles with silica on the surface, and an emulsion containing polymer particles with silica refers to one in which such thermoplastic polymer particles is contained in the dispersion state in a medium.

The polymer particles with silica has the form in which the surface of the thermoplastic polymer particles is covered with colloidal silica, and the polymer particles with silica in the hydrophilic layer have an island structure in which colloidal silica is separately located on the polymer particle surface.

When the hydrophilic layer is heated during its formation, the polymer particles in the hydrophilic layer deform by heating, however, the polymer particles with silica maintain the island structure as described above.

The medium for the emulsion in the invention containing polymer particles with silica is preferably water.

Examples of the polymer for the polymer particles include acryl resin, styrene-acryl copolymer, styrene-butadiene copolymer, ethylene-vinyl acetate copolymer, vinyl chloride-vinyl acetate copolymer, ethylene-vinyl acetate-vinyl chloride copolymer, polypropylene, polyester, phenoxy resin, phenol resin, and butyral resin.

Among these, the acryl resin is preferably used in the invention, in view of on-press development property and printing durability.

The colloidal silica described above refers to silicon dioxide particles having a particle size of not more than 0.1 μm. The colloidal silica is in the form of solid fine powder, suspended in water as a hydrate, or dispersed in a solvent other than water.

As a method of preparing colloidal silica, there are a method in which silicon tetrahalide is poured into water and a method in which an alkali silicate solution is gradually neutralized and ions produced such as an alkali ion are removed.

The emulsion containing polymer particles with silica can be obtained by a method disclosed in for example, Japanese Patent O.P.I. Publication Nos. 59-71316 and 60-127371, in which a comonomer, a monomer having in the molecule an polymerizable unsaturated double bond and an alkoxysilane group or vinyl silane, and colloidal silica are mixed and subjected to emulsion polymerization to prepare polymer particles, where silica components are fixed on the surface of the resulting polymer particles during polymerization.

As another method of preparing the emulsion, there is a method disclosed in for example, International Symposium on Polymeric Microspheres Prints, 1991, 181, in which employing hydrolysable alkoxysilane such as ethyl orthosilicate which is immiscible in water, silica components are precipitated and fixed on the surface of the polymer particles to have been prepared.

As the polymer of the polymer particles, a polymer having a softening point of from 45 to 80° C. is preferably used in view of on-press development property, sensitivity, and printing durability.

The particle size of the polymer particles is preferably from 200 to 1500 nm, and more preferably from 400 to 1000 nm, when the polymer particles are used in the hydrophilic layer or the image formation layer.

The rate (by weight) of the silica to the polymer particles (silica/polymer particles) in the polymer particles with silica is preferably from 10/1 to 2/1, and more preferably from 8/1 to 4/1.

Examples of the emulsion containing polymer particles with silica include Mowinyl 8055 and Mowinyl 8030 each produced by Clariant Polymer Co., Ltd.

### (Hydrophilic Layer)

The hydrophilic layer in the invention is a layer capable of forming non-image portions which repel printing ink during printing, and contains a hydrophilic material and polymer particles with silica.

The hydrophilic layer may be a single layer or plural layers.

The hydrophilic material used in the hydrophilic layer is preferably a substantially water-insoluble hydrophilic material, and especially preferably a metal oxide.

The metal oxide is preferably in the form of metal oxide particles. Examples of the metal oxide particles include colloidal silica particles, an alumina sol, a titania sol and another metal oxide sol. The metal oxide particles may have any shape such as spherical, needle-like, and feather-like shape. The average particle size is preferably from 3 to 100 nm, and plural kinds of metal oxide each having a different size may be used in combination. The surface of the particles may be subjected to surface treatment.

The metal oxide particles can be used as a binder, utilizing its layer forming ability. The metal oxide particles are suitably used in a hydrophilic layer since they minimize lowering of the hydrophilicity of the layer as compared with an organic compound binder.

Among the above-mentioned, colloidal silica is particularly preferred. The colloidal silica has a high layer forming ability under a drying condition with a relative low temperature, and can provide a good layer strength even in a layer containing a material containing no carbon in an amount of not less than 91% by weight.

It is preferred that the colloidal silica used in the invention is necklace-shaped colloidal silica or colloidal silica particles having an average particle size of not more than 20 nm, each being described later. Further, it is preferred that the colloidal silica provides an alkaline colloidal silica solution as a colloid solution.

The necklace-shaped colloidal silica to be used in the invention is a generic term of an aqueous dispersion system of spherical silica having a primary particle size of the order of nm. The necklace-shaped colloidal silica to be used in the invention means a “pearl necklace-shaped” colloidal silica formed by connecting spherical colloidal silica particles each having a primary particle size of from 10 to 50 μm so as to attain a length of from 50 to 400 nm.

The term of “pearl necklace-shaped” means that the image of connected colloidal silica particles is like to the shape of a pearl necklace.

The bonding between the silica particles forming the necklace-shaped colloidal silica is considered to be —Si—O—Si—, which is formed by dehydration of —SiOH groups located on the surface of the silica particles. Concrete examples of the necklace-shaped colloidal silica include Snowtex-PS series produced by Nissan Kagaku Kogyo, Co., Ltd.

As the products, there are Snowtex-PS-S (the average particle size in the connected state is approximately 110 nm), Snowtex-PS-M (the average particle size in the connected state is approximately 120 nm) and Snowtex-PS-L (the average particle size in the connected state is approximately 170 nm). Acidic colloidal silicas corresponding to each of the above-mentioned are Snowtex-PS-S-O, Snowtex-PS-M-O and Snowtex-PS-L-O, respectively.

The necklace-shaped colloidal silica is preferably used in a hydrophilic layer as a porosity providing material for hydrophilic matrix phase, and porosity and strength of the layer can be secured by its addition to the layer.

Among them, the use of Snowtex-PS-S, Snowtex-PS-M or Snowtex-PS-L, each being alkaline colloidal silica particles, is particularly preferable since the strength of the hydrophilic layer is increased and occurrence of background contamination is inhibited even when a lot of prints are printed.

It is known that the binding force of the colloidal silica particles is become larger with decrease of the particle size. The average particle size of the colloidal silica particles to be used in the invention is preferably not more than 20 nm, and more preferably 3 to 15 nm.

As above-mentioned, the alkaline colloidal silica particles show the effect of inhibiting occurrence of the background contamination. Accordingly, the use of the alkaline colloidal silica particles is particularly preferable.

Examples of the alkaline colloidal silica particles having the average particle size within the foregoing range include Snowtex-20 (particle size: 10 to 20 nm), Snowtex-30 (particle size: 10 to 20 nm), Snowtex-40 (particle size: 10 to 20 nm), Snowtex-N (particle size: 10 to 20 nm), Snowtex-S (particle size: 8 to 11 nm) and Snowtex-XS (particle size: 4 to 6 nm), each produced by Nissan Kagaku Co., Ltd.

The colloidal silica particles having an average particle size of not more than 20 nm, when used together with the necklace-shaped colloidal silica as described above, is particularly preferred, since appropriate porosity of the layer is maintained and the layer strength is further increased.

The ratio of the colloidal silica particles having an average particle size of not more than 20 nm to the necklace-shaped colloidal silica is preferably from 95/5 to 5/95, more preferably from 70/30 to 20/80, and most preferably from 60/40 to 30/70.

The hydrophilic layer in the invention preferably contains porous metal oxide particles as metal oxide particles. The porous metal oxide particles are preferably porous silica particles, porous aluminosilicate particles or zeolite particles.

The porous silica particles are ordinarily produced by a wet method or a dry method. By the wet method, the porous silica particles can be obtained by drying and pulverizing a gel prepared by neutralizing an aqueous silicate solution, or pulverizing the precipitate formed by neutralization. By the dry method, the porous silica particles are prepared by combustion of silicon tetrachloride together with hydrogen and oxygen to precipitate silica. The porosity and the particle size of such particles can be controlled by variation of the production conditions.

The porous silica particles prepared from the gel by the wet method is particularly preferred.

The porous aluminosilicate particles can be prepared by the method described in, for example, JP O.P.I. No. 10-71764. Thus prepared aluminosilicate particles are amorphous complex particles synthesized by hydrolysis of aluminum alkoxide and silicon alkoxide as the major components. The particles can be synthesized so that the ratio of alumina to silica in the particles is within the range of from 1:4 to 4:1. Complex particles composed of three or more components prepared by an addition of another metal alkoxide may also be used in the invention. In such a particle, the porosity and the particle size can be controlled by adjustment of the production conditions.

The porosity of the particles is preferably not less than 1.0 ml/g, more preferably not less than 1.2 ml/g, and most preferably of from 1.8 to 2.5 ml/g, in terms of pore volume before the dispersion.

The particle size of the particles in the hydrophilic layer (including the particles in the dispersion state) is preferably not more than 1 μm, and more preferably not more than 0.5 μm.

The particle size of the porous inorganic particles in the hydrophilic layer is preferably not more than 1 μm, and more preferably not more than 0.5 μm.

The hydrophilic layer of the printing plate material in the invention can contain layer structural clay mineral particles as a metal oxide. Examples of the layer structural clay mineral particles include a clay mineral such as kaolinite, halloysite, talk, smectite such as montmorillonite, beidellite, hectorite and saponite, vermiculite, mica and chlorite; hydrotalcite; and a layer structural polysilicate such as kanemite, makatite, ilerite, magadiite and kenyte. Among them, ones having a higher electric charge density of the unit layer are higher in the polarity and in the hydrophilicity. Preferable charge density is not less than 0.25, more preferably not less than 0.6. Examples of the layer structural mineral particles having such a charge density include smectite having a negative charge density of from 0.25 to 0.6 and bermiculite having a negative charge density of from 0.6 to 0.9. Synthesized fluorinated mica is preferable since one having a stable quality, such as the particle size, is available. Among the synthesized fluorinated mica, swellable one is preferable and one freely swellable is more preferable.

An intercalation compound of the foregoing layer structural mineral particles such as a pillared crystal, or one treated by an ion exchange treatment or a surface treatment such as a silane coupling treatment or a complication treatment with an organic binder is also usable.

The structural mineral particles are preferably in the plate form, and have an average particle size (an average of the largest particle length) of preferably not more than 20 μm, and an average aspect ratio (the largest particle length/the particle thickness) of preferably not less than 20 μm, in a state contained in the layer including the case that the particles are subjected to a swelling process and a dispersing layer-separation process. The structural mineral particles have an average particle size of more preferably not more than 5 μm, and an average aspect ratio of more preferably not less than 50 μm, and have an average particle size of still more preferably not more than 1 μm, and an average aspect ratio of still more preferably not less than 50 μm. When the particle size is within the foregoing range, continuity to the parallel direction, which is a trait of the layer structural particle, and softness, are given to the coated layer so that a strong dry layer in which a crack is difficult to be formed can be obtained. The coating solution containing the layer structural clay mineral particles in a large amount can minimize particle sedimentation due to a viscosity increasing effect.

The content of the layer structural clay mineral particles is preferably from 0.1 to 30% by weight, and more preferably from 1 to 10% by weight based on the total weight of the layer. Particularly, the addition of the swellable synthesized fluorinated mica or smectite is effective if the adding amount is small. The layer structural clay mineral particles may be added in the form of powder to a coating liquid, but it is preferred that gel of the particles which is obtained by being swelled in water, is added to the coating liquid in order to obtain a good dispersity according to an easy coating liquid preparation method which requires no dispersion process comprising dispersion due to media.

An aqueous solution of a silicate is also usable as another additive to the hydrophilic matrix phase in the invention. An alkali metal silicate such as sodium silicate, potassium silicate or lithium silicate is preferable, and the ratio SiO₂/M₂O is preferably selected so that the pH value of the coating liquid after addition of the silicate does not exceed 13 in order to prevent dissolution of the porous metal oxide particles or the colloidal silica particles.

An inorganic polymer or an inorganic-organic hybrid polymer prepared by a sol-gel method employing a metal alkoxide. Known methods described in S. Sakka “Application of Sol-Gel Method” or in the publications cited in the above publication can be applied to prepare the inorganic polymer or the inorganic-organic hybrid polymer by the sol-gel method.

The hydrophilic layer may contain a hydrophilic organic resin.

Examples of the hydrophilic organic resin include polyethylene oxide, polypropylene oxide, polyvinyl alcohol, polyethylene glycol (PEG), polyvinyl ether, a conjugation diene polymer latex such as a styrene-butadiene copolymer latex or a methyl methacrylate-butadiene copolymer latex, an acryl polymer latex, a vinyl polymer latex, polyacrylamide, and polyvinyl pyrrolidone. In the invention, polysaccharides are preferred.

A cationic resin may also be contained in the hydrophilic layer. Examples of the cationic resin include a polyalkylene-polyamine such as a polyethyleneamine or polypropylenepolyamine or its derivative, an acryl resin having a tertiary amino group or a quaternary ammonium group and diacrylamine. The cationic resin may be added in a form of fine particles. Examples of such particles include the cationic microgel described in Japanese Patent O.P.I. Publication No. 6-161101.

It is preferred in the invention that the hydrophilic organic resin is water-soluble, and is contained in the hydrophilic layer in such a state that at least a part of the resin is capable of being dissolved in water.

In the invention, saccharides are preferred as a water-soluble material contained in the hydrophilic layer.

As the saccharides, oligosaccharides described later can be used, and polysaccharides is preferably used.

As the polysaccharide, starches, celluloses, polyuronic acid and pullulan can be used. Among them, a cellulose derivative such as a methyl cellulose salt, a carboxymethyl cellulose salt or a hydroxyethyl cellulose salt is preferable, and a sodium or ammonium salt of carboxymethyl cellulose is more preferable.

This is because the polysaccharides can form a preferred surface shape of the hydrophilic layer. The surface of the hydrophilic layer preferably has a concavo-convex structure having a pitch of from 0.1 to 50 μm such as the grained aluminum surface of an aluminum PS plate. The water retention ability and the image maintaining ability are raised by such a concavo-convex structure of the surface.

Such a concavo-convex structure can also be formed by adding in an appropriate amount a filler having a suitable particle size to the coating liquid of the hydrophilic layer. However, the concavo-convex structure is preferably formed by coating a coating liquid for the hydrophilic layer containing the alkaline colloidal silica and the water-soluble polysaccharide so that the phase separation occurs at the time of drying the coated liquid, whereby a structure is obtained which provides a good printing performance.

The form (such as pitch or surface roughness) of the concavo-convex structure can be suitably controlled by kinds or addition amount of alkaline colloidal silica, kinds or addition amount of water-soluble polysaccharides or kinds or addition amount of other additives, or by a solid content of a coating solution, a wet thickness or a drying condition.

The pitch in the concavo-convex structure is preferably from 0.2 to 30 μm, and more preferably from 0.5 to 20 μm.

The concavo-convex structure in the invention may be a multi-concavo-convex structure, in which a concavo-convex structure having a greater pitch has a concavo-convex structure having a smaller pitch in it. The surface roughness is preferably from 100 to 1000 nm, and more preferably from 150 to 600 nm in terms of Ra.

Herein, Ra is determined according to a method described in JIS B0601, measured through an optical interference surface roughness meter available on the market.

The thickness of the hydrophilic layer is preferably from 0.01 to 50 μm, more preferably from 0.2 to 10 μm, and still more preferably from 0.5 to 3 μm.

The hydrophilic layer in the invention is formed by providing a hydrophilic layer coating solution comprising an emulsion containing polymer particles with silica, coating the hydrophilic layer coating solution on a support, and drying it.

The hydrophilic layer coating solution is comprised of the afore-mentioned materials used in the hydrophilic layer and a coating solvent.

Examples of the coating solvent include water, alcohols and polyhydric alcohols. The coating solvent is preferably water. A water-soluble surfactant may be added for improving the coating ability of the coating liquid for the hydrophilic layer in the invention.

A silicon atom-containing surfactant and a fluorine atom-containing surfactant are preferably used. The silicon atom-containing surfactant is especially preferred in that it minimizes printing contamination.

The content of the surfactant is preferably from 0.01 to 3% by weight, and more preferably from 0.03 to 1% by weight based on the total weight of the hydrophilic layer (or the solid content of the coating liquid).

The content of the surfactant is preferably from 0.01 to 3% by weight, and more preferably from 0.03 to 1% by weight based on the total weight of the hydrophilic layer (or the solid content of the coating liquid).

The hydrophilic layer in the invention can contain a phosphate. Since a coating liquid for the hydrophilic layer is preferably alkaline, the phosphate to be added to the hydrophilic layer is preferably sodium phosphate or sodium monohydrogen phosphate. The addition of the phosphate provides improved reproduction of dots at shadow portions.

The content of the phosphate is preferably from 0.1 to 5% by weight, and more preferably from 0.5 to 2% by weight in terms of amount excluding hydrated water.

As the coating method of the hydrophilic layer coating layer, there are known coating methods such as a wire bar coating method, a curtain coating method, and a slide coater coating method.

In the invention, the hydrophilic layer containing polymer particles with silica provides excellent on-press development property and high printing durability. This is supposed to be due to the reason that strength of the hydrophilic layer and adhesion of the hydrophilic layer to the support is enhanced by interaction of the hydrophilic materials described above with the silica of the polymer particles with silica in the invention.

The content of the polymer particles with silica in the hydrophilic layer is preferably from 0.5 to 30% by weight and more preferably from 1 to 10% by weight, in view of printing durability and anti-stain property.

### (Image Formation Layer)

The image formation layer in the invention is a layer capable of forming image portions on imagewise heating or imagewise. The image formation layer is preferably a thermosensitive image formation layer.

The image formation layer, particularly when it is capable of being subjected to on-press development, markedly exhibits the advantageous effects of the invention. On-press development means developing, without using any specific developer, a printing plate material to have been imagewise exposed on a printing press by supplying dampening water or both of dampening water and printing ink to it, whereby a printing plate is obtained on the printing press, followed by printing.

The thermosensitive image formation layer is an image formation layer capable of forming an image on imagewise heating.

As the imagewise heating method, there are a method of imagewise heating directly an image formation layer employing a heater, and a method of imagewise heating an image formation layer employing heat generated on imagewise exposure by a laser. In the invention, imagewise exposure by a laser is preferred.

Heated portions at a thermosensitive image formation layer form ink-receptive image portions.

The thermosensitive image formation layer contains a thermosensitive material, which deforms, melts or softens on heating.

The thermosensitive material is preferably a thermoplastic material. As the thermoplastic material, heat melting particles or heat fusible particles are preferably used.

The heat melting particles used in the invention are particularly particles having a low melt viscosity, which are particles formed from materials generally classified into wax. The materials preferably have a softening point of from 40° C. to 120° C. and a melting point of from 60° C. to 150° C., and more preferably a softening point of from 40° C. to 100° C. and a melting point of from 60° C. to 120° C. The melting point less than 60° C. has a problem in storage stability and the melting point exceeding 300° C. lowers ink receptive sensitivity.

Materials usable include paraffin, polyolefin, polyethylene wax, microcrystalline wax, and fatty acid wax. The molecular weight thereof is approximately from 800 to 10,000. A polar group such as a hydroxyl group, an ester group, a carboxyl group, an aldehyde group and a peroxide group may be introduced into the wax by oxidation to increase the emulsification ability. Moreover, stearoamide, linolenamide, laurylamide, myristylamide, hardened cattle fatty acid amide, parmitylamide, oleylamide, rice bran oil fatty acid amide, palm oil fatty acid amide, a methylol compound of the above-mentioned amide compounds, methylenebisstearoamide and ethylenebisstearoamide may be added to the wax to lower the softening point or to raise the working efficiency. A cumarone-indene resin, a rosin-modified phenol resin, a terpene-modified phenol resin, a xylene resin, a ketone resin, an acryl resin, an ionomer and a copolymer of these resins may also be usable.

Among them, polyethylene, microcrystalline wax, fatty acid ester and fatty acid are preferably contained. A high sensitive image formation can be performed since these materials each have a relative low melting point and a low melt viscosity. These materials each have a lubrication ability.

Accordingly, even when a shearing force is applied to the surface layer of the printing plate precursor, the layer damage is minimized, and resistance to stain which may be caused by scratch is further enhanced.

The heat melting particles are preferably dispersible in water. The average particle size thereof is preferably from 0.01 to 10 μm, and more preferably from 0.1 to 3 μm, in view of on-press developability, resistance to background contamination, or dissolving power.

The composition of the heat melting particles may be continuously varied from the interior to the surface of the particles. The particles may be covered with a different material.

Known microcapsule production method or sol-gel method can be applied for covering the particles.

The heat melting particle content of the layer is preferably 1 to 90% by weight, and more preferably 5 to 80% by weight based on the total layer weight.

The heat fusible particles in the invention include thermoplastic hydrophobic polymer particles. Although there is no specific limitation to the upper limit of the softening point of the thermoplastic hydrophobic polymer, the softening point is preferably lower than the decomposition temperature of the polymer. The weight average molecular weight (Mw) of the thermoplastic hydrophobic polymer is preferably within the range of from 10,000 to 1,000,000.

Examples of the polymer consisting the polymer particles include a diene (co)polymer such as polypropylene, polybutadiene, polyisoprene or an ethylene-butadiene copolymer; a synthetic rubber such as a styrene-butadiene copolymer, a methyl methacrylate-butadiene copolymer or an acrylonitrile-butadiene copolymer; a (meth)acrylate (co)polymer or a (meth)acrylic acid (co)polymer such as polymethyl methacrylate, a methyl methacrylate-(2-ethylhexyl)acrylate copolymer, a methyl methacrylate-methacrylic acid copolymer, or a methyl acrylate-(N-methylolacrylamide); polyacrylonitrile; a vinyl ester (co)polymer such as a polyvinyl acetate, a vinyl acetate-vinyl propionate copolymer and a vinyl acetate-ethylene copolymer, or a vinyl acetate-2-hexylethyl acrylate copolymer; and polyvinyl chloride, polyvinylidene chloride, polystyrene and a copolymer thereof. Among them, the (meth)acrylate polymer, the (meth)acrylic acid (co)polymer, the vinyl ester (co)polymer, the polystyrene and the synthetic rubbers are preferably used.

The heat fusible particles are preferably dispersible in water. The average particle size of the heat fusible particles is preferably from 0.01 to 10 μm, and more preferably from 0.1 to 3 μm, in view of on-press developability, resistance to background contamination or dissolving power.

Further, the composition of the heat fusible particles may be continuously varied from the interior to the surface of the particles. The particles may be covered with a different material.

As a covering method, known methods such as a microcapsule method and a sol-gel method are usable. The heat fusible particle content of the layer is preferably from 1 to 90% by weight, and more preferably from 5 to 80% by weight based on the total weight of the layer.

As the microcapsules, there are microcapsules encapsulating hydrophobic materials disclosed in for example, Japanese Patent O.P.I. Publication Nos. 2002-2135 and 2002-19317. The average particle size of the microcapsules is preferably from 0.1 to 10 μm, more preferably from 0.5 to 5 μm, and most preferably from 0.5 to 3 μm.

In the invention, the image formation layer in the invention containing heat fusible particles can further contain a water soluble material.

When the image formation layer at unexposed portions is removed on a press with dampening water or ink, the water soluble material makes it possible to easily remove the layer.

Regarding the water soluble material, those described above as water soluble materials to be contained in the hydrophilic layer can be used. The image formation layer in the invention preferably contains saccharides, and more preferably contains oligosaccharides.

Since the oligosaccharides are easily dissolved in water, removal on a press of unexposed portions of an oligosaccharide-containing layer can be easily carried out, without requiring a specific system, and can be carried out in the same manner as in the beginning of printing of a conventional PS plate, which does not increase loss of prints at the beginning of printing. Use of the oligosaccharide does not lower hydrophilicity of the hydrophilic layer and can maintain good printing performance of the hydrophilic layer.

The oligosaccharide is a water-soluble crystalline substance generally having a sweet taste, which is formed by a dehydration condensation reaction of plural monosaccharide molecules. The oligosaccharide is one kind of o-glycoside having a saccharide as the aglycon. The oligosaccharide is easily hydrolyzed by an acid to form a monosaccharide, and is classified according to the number of monosaccharide molecules of the resulting hydrolysis compounds, for example, into disaccharide, trisaccharide, tetrasaccharide, and pentasscharide. The oligosaccharide referred to in the invention means di- to deca-saccharides.

The oligosaccharide is classified into a reducing oligosaccharide and a non-reducing oligosaccharide according to presence or absence of a reducing group in the molecule. The oligosaccharide is also classified into a homo-oligosaccharide composed of the same kind of monosaccharide and a hetero-oligosaccharide composed of two or more kinds of monosaccharides.

The oligosaccharide naturally exists in a free state or a glycoside state. Moreover, various oligosaccharides are formed by glycosyl transition by action of an enzyme.

The oligosaccharide frequently exists in a hydrated state in an ordinary atmosphere. The melting points of the hydrated one and anhydrous one are different from each other.

In the invention, the layer containing a saccharide is preferably formed coating an aqueous coating solution containing the saccharide on a support. When an oligossccharide in the layer formed from the aqueous coating solution is one capable of forming a hydrate, the melting point of the oligosaccharide is that of its hydrate.

Since the oligosaccharides, having a relatively low melting point, also melt within the temperature range at which heat melting particles melt or heat fusible particles fuse, they do not cause image formation inhibition resulting from permeation of the heat melting particles into the porous hydrophilic layer and/or fusion adhesion of the heat fusible particles to the hydrophilic layer.

Among the oligosaccharides, trehalose with comparatively high purity is available on the market, and has an extremely low hygroscopicity, although it has high water solubility, providing excellent storage stability and excellent development property on a printing press. When oligosaccharide hydrates are heat melted to remove the hydrate water and solidified, the oligosaccharide is in a form of anhydride for a short period after solidification. Trehalose is characterized in that a melting point of trehalose anhydride is not less than 100° C. higher that that of trehalose hydrate. This characteristics provides a high melting point and reduced heat fusibility at exposed portions of the trehalose-containing layer immediately after heat-fused by infrared ray exposure and re-solidified, preventing image defects at exposure such as banding from occurring.

Trehalose is preferable among the oligosaccharides. The oligosaccharide content of the layer is preferably from 1 to 90% by weight, and more preferably from 10 to 80% by weight, based on the total weight of the layer.

In the invention regarding claim 2, the image formation layer containing polymer particles with silica provides excellent on-press development property and excellent printing durability. This is supposed to be due to the reason that strength of the image formation layer and adhesion of the image formation layer to the hydrophilic layer is enhanced by interaction of the thermosensitive materials or hydrophilic materials contained in the image formation layer with the silica or polymer particles in the invention or interaction of components contained in the hydrophilic layer with the silica or polymer particles in the invention.

The content of the polymer particles with silica in the image formation layer is preferably from 1 to 80% by weight, and more preferably from 10 to 80% by weight, based on the weight of the image formation layer, in view of sensitivity and printing durability.

### (Light-to-Heat Conversion Material)

In the invention, when the image formation layer is a thermosensitive image formation layer, it is preferred that the hydrophilic layer or image formation layer in the invention contains a light-to-heat conversion material.

As the light-to-heat conversion material, there is an infrared absorbing dye or pigment.

### (Infrared Absorbing Dye)

Examples of the infrared absorbing dye include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound.

Specifically, there are those disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These may be used singly or in combination.

As the pigment, there are carbon, graphite, a metal and a metal oxide.

Furnace black and acetylene black is preferably used as the carbon. The graininess (d₅₀) thereof is preferably not more than 100 nm, and more preferably not more than 50 nm.

The graphite is one having a particle size of preferably not more than 0.5 μm, more preferably not more than 100 nm, and most preferably not more than 50 nm.

As the metal, any metal can be used as long as the metal is in a form of particles having preferably a particle size of not more than 0.5 μm, more preferably not more than 100 nm, and most preferably not more than 50 nm. The metal may have any shape such as spherical, flaky and needle-like. Colloidal metal particles such as those of silver or gold are particularly preferred.

As the metal oxide, there are materials having black color in the visible regions or materials which are electro-conductive or semi-conductive. Examples of the former include black iron oxide and black complex metal oxides containing at least two metals.

As the metal oxide, black complex metal oxides containing at least two metals are used. Examples of the black complex metal oxides containing at least two metals include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 9-27393, 9-25126, 9-237570, 9-241529 and 10-231441.

The complex metal oxide is preferably a Cu—Cr—Mn type complex metal oxide or a Cu—Fe—Mn type complex metal oxide. The Cu—Cr—Mn type complex metal oxides are preferably subjected to the treatment disclosed in Japanese Patent O.P.I. Publication Nos. 8-27393 in order to reduce isolation of a 6-valent chromium ion.

These complex metal oxides provide high light heat conversion efficiency relative to the addition amount thereof in the light sensitive layer. The average primary particle size of these complex metal oxides is preferably from 0.001 to 1.0 μm, and more preferably from 0.01 to 0.5 μm. The primary average particle size of from 0.001 to 1.0 μm improves light heat conversion efficiency relative to the addition amount of the particles, and the average primary particle size of from 0.05 to 0.5 μm further improves light heat conversion efficiency relative to the addition amount of the particles. Light heat conversion efficiency to the addition amount of the particles is greatly influenced by degree of dispersion of the particles. The higher the degree of dispersion of the particles, the higher the light heat conversion efficiency.

Accordingly, these complex metal oxide particles are preferably dispersed according to a known method to prepare a dispersion (paste), which is added to a coating solution. Complex metal oxide particles with an average primary particle size of less than 0.01 μm are difficult to disperse. When these complex metal oxide particles are dispersed, a dispersant can be used appropriately. The used amount of the dispersant is preferably from 0.01 to 5% by weight, and more preferably from 0.1 to 2% by weight, based on the weight of complex metal oxide particles.

Examples of the materials which are electro-conductive or semi-conductive include Sb-doped SnO₂ (ATO), Sn-added In₂O₃ (ITO), TiO₂, TiO prepared by reducing TiO₂ (titanium oxide nitride, generally titanium black). Particles prepared by covering a core material such as BaSO₄, TiO₂, 9Al₂O₃.2B₂O and K₂O.nTiO₂ with these metal oxides are usable. These oxides are particles having a particle size of not more than 0.5 μm, preferably not more than 100 nm, and more preferably not more than 50 nm.

Among these light-to-heat conversion materials, the infrared absorbing dye or black complex metal oxides containing at least two metals are more preferred.

The content of the light-to-heat conversion material is from 0.1 to 50% by weight, preferably from 1 to 30% by weight, and more preferably from 3 to 25% by weight, based on the weight of layer containing the light-to-heat conversion material.

In the invention, at least one back coat layer is preferably provided on the side of the support opposite the image formation layer to be formed, from the viewpoints of handling properties or storage stability.

### (Plastic Support)

The plastic support in the invention is a plastic sheet capable of carrying the hydrophilic layer and the image formation layer. Examples of resin for the plastic sheet include polyethylene terephthalate, polyethylene naphthalate (PEN), polyimide, polyamide, polycarbonate, polysulfone, polyphenylene oxide, and cellulose ester.

Among these, polyester such as PET or PEN is preferred, and PET is especially preferred, in view of handling with ease.

PET is a polycondensate of terephthalic acid and ethylene glycol, and PEN is a polycondensate of naphthalene dicarboxylic acid and ethylene glycol.

The PET and PEN may be those obtained by condensation polymerization of the dicarboxylic acid and the diol described above, and optionally one or more kinds of a third component. As the third component, there is a compound having a divalent ester-forming functional group capable of forming an ester.

Examples of the dicarboxylic acid include isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylthioether dicarboxylic acid, diphenylketone dicarboxylic acid and diphenylindane dicarboxylic acid.

Examples of the glycol include propylene glycol, tetramethylene glycol, cyclohexanedimethanol, 2,2-bis(4-hydroxyphenyl)propane, 2,2-bis(4-hydroxyethoxyphenyl)propane, bis(4-hydroxyphenyl)-sulfone, bisphenolfluorene dihydroxyethyl ether, diethylene glycol, hydroquinone, cyclohexane diol.

As the third component, a polycarboxylic acid or a polyhydric alcohol may be used, but the content of the polycarboxylic acid or polyhydric alcohol is preferably from 0.001 to 5% by weight based on the total weight of constituents of polyester.

The intrinsic viscosity of the polyester is preferably from 0.5 to 0.8. Polyesters having different viscosity may be used as a mixture of two or more kinds thereof.

A synthetic method of the polyester in the invention is not specifically limited, and the polyester can be synthesized according to a conventional polycondensation method. As the synthetic method, there is a direct esterification method in which a dicarboxylic acid is directly reacted with a diol or an ester exchange method in which dialkyl ester as a dicarboxylic acid component is reacted with a diol while heating under reduced pressure where produced diol is removed.

As catalysts, an ester exchange catalyst ordinarily used in synthesis of polyesters, a polymerization catalyst or a heat-resistant stabilizer can be used. Examples of the ester exchange catalyst include Ca(OAc)₂.H₂O, Zn(OAc)₂.2H₂O, Mn(OAc)₂.4H₂O, and Mg(OAc)₂.4H₂O. Examples of the polymerization catalyst include Sb₂O₃ and GeO₂. Examples of the heat-resistant stabilizer include Phosphoric acid, phosphorous acid, PO(OH)(CH₃)₃, PO(OH)(OC₆H₅)₃, and P(OC₆H₅)₃. During synthesis of polyesters, an anti-stain agent, a crystal nucleus agent, a slipping agent, an anti-blocking agent, a UV absorber, a viscosity adjusting agent, a transparentizing agent, an anti-static agent, a pH adjusting agent, a dye or pigment may be added.

It is preferred that the thickness of the plastic support is preferably from 100 to 400 μm, and more preferably from 100 to 300 μm, in view of printability or a handling property.

In the invention, the thickness of the support is determined according to the following: lines are formed at an interval of 10 cm in both the transverse and longitudinal directions on a 50 cm square support to form 16 points of intersection. The thicknesses at the 16 points of intersection are measured, and the average thickness thereof is determined.

The polyester sheet is prepared by a method comprising the steps of melting a thermoplastic resin at a temperature of from the melting point (Tm) to Tm+50° C., filtering the melted resin through a filter, extruding the filtrate from a T-die, and casting it on a casting drum at a glass transition point (Tg)−50° C. to Tg to form an unstretched sheet. As a method to obtain the sheet with the thickness variation falling within the above-described range, a static electricity application method is preferably used. The unstretched sheet is stretched at from Tg to Tg+50° C. by a stretching magnification of from 2 to 4. As another method to obtain the sheet with the thickness variation falling within the above-described range, a multi-stretching method is preferably used, in which temperature at a later stretching step is higher than that at a preceding stretching step by preferably 1 to 30° C., and more preferably 2 to 15° C.

The stretching magnification at the preceding stretching step is preferably 0.25 to 0.75 times, and more preferably 0.3 to 0.5 times the stretching magnification at the later stretching step. Thereafter, it is preferred that the stretched sheet is maintained at Tg−30° C. to Tg for 5 to 60 seconds, preferably 10 to 40 seconds, and stretched in the lateral direction at Tg to Tg+50° C. by a stretching magnification of 2.5 to 5. The resulting sheet, while held through a chuck at (Tm−50° C.) to (Tm−5° C.), is heat fixed for 5 to 120 seconds, where the interval of the chucks in the lateral direction is preferably reduced by more than 0 to 10% (heat relaxation). The heat fixed sheet is cooled, subjected to knurling treatment to give a knurl of 10 to 100 μm at the sheet edge, and wounded around a spool. Thus, a multi-axially stretched sheet is preferably obtained.

### (Heat Treatment of Support)

In the invention, the polyester sheet after stretched and heat-fixed is preferably subjected to heat treatment in order to stabilize dimension of a printing plate and minimize “out of color registration” during printing.

It is preferred that after the sheet has been stretched, heat fixed, cooled, and wound around a spool, the sheet is unwound at a separate process, and heat treated as follows.

As the heat treatment methods in the invention, there are a transporting method in which the film sheet is transported while holding the both ends of the sheet with a pin or a clip, a transporting method in which the film sheet is roller transported employing plural transporting rollers, an air transporting method in which the sheet is transported while lifting the sheet by blowing air to the sheet (heated air is blown to one or both sides of the sheet from plural nozzles), a heating method which the sheet is heated by radiation heat from for example, an infrared heater, a heating method in which the sheet is brought into contact with plural heated rollers to heat the sheet, a transporting method in which the sheet hanging down by its own weight is wound around an up-take roller, and a combination thereof.

Tension at heat treatment can be adjusted by controlling torque of an up-take roll and/or a feed-out roll and/or by controlling load applied to the dancer roller provided in the process. When the tension is changed during or after the heat treatment, an intended tension can be obtained by controlling load applied to the dancer roller provided in the step before, during and/or after the heat treatment.

When the transporting tension is changed while vibrating the sheet, it is useful to reduce the distance the heated rollers.

In order to reduce dimensional change on heat processing (thermal development), which is carried out later, without inhibiting thermal contraction, it is desirable to lower the transporting tension as much as possible, and lengthen the heat treatment time. The heat treatment temperature is preferably in the range of from Tg+50° C. to Tg+150° C. In this temperature range, the transporting tension is preferably from 5 Pa to 1 MPa, more preferably from 5 Pa to 500 kPa, and most preferably from 5 Pa to 200 kPa, and the heat treatment time is preferably from 30 seconds to 30 minutes, and more preferably from 30 seconds to 15 minutes.

In order to increase adhesion between the support and a coating layer, it is preferred that the surface of the support is subjected to adhesion increasing treatment or is coated with a subbing layer.

### (Adhesion Increasing Treatment and Subbing Layer Coating)

Examples of the adhesion increasing treatment include corona discharge treatment, flame treatment, plasma treatment and UV light irradiation treatment.

The subbing layer is preferably a layer containing gelatin or latex. The electrically conductive layer, for example, an electrically conductive polymer-containing layer disclosed in items [0031] through [0073] of Japanese Patent O.P.I. Publication No. 7-20596 or a metal oxide-containing layer disclosed in items [0074] through [0081] of Japanese Patent O.P.I. Publication No. 7-20596 is preferably provided on the support. The electrically conductive layer may be provided on any surface side of the support, but is provided preferably on the surface of the support opposite the image formation layer. The electrically conductive layer improves electrification property, reduces dust adhesion, and greatly lowers printing failure such as white spot occurrence during printing.

The subbing layer may contain a polyvinylidene resin.

The support in the invention is preferably a plastic sheet, but may be a composite support in which a plate of a metal (for example, iron, stainless steel or aluminum) or a polyethylene-laminated paper sheet is laminated onto the plastic sheet. The composite support may be one in which the lamination is carried out before any layer is coated on the support, one in which the lamination is carried out after any layer has been coated on the support, or one in which the lamination is carried out immediately before mounted on a printing press.

Fine particles having a size of from 0.01 to 10 μm are preferably incorporated in an amount of from 1 to 1000 ppm into the support, in improving handling property. (Fine Particles)

Herein, the particles may be organic or inorganic material. Examples of the inorganic material include silica described in Swiss Patent 330158, glass powder described in French Patent 296995, and carbonate salts of alkaline earth metals, cadmium or zinc described in British Patent 1173181. Examples of the organic material include starch described in U.S. Pat. No. 2,322,037, starch derivatives described such as in Belgian Patent 625451 and British Patent 981198, polyvinyl alcohol described in JP-B 44-3643, polystyrene or polymethacrylate described in Swiss Patent 330158, polyacrylonitrile described in U.S. Pat. No. 3,079,257 and polycarbonate described in U.S. Pat. No. 3,022,169. The shape of the particles may be in a regular form or irregular form.

The plastic support in the invention has a coefficient of elasticity of preferably from 300 to 800 kg/mm², and more preferably from 400 to 600 kg/mm², in view of improving handling property of the printing plate material of the invention.

The coefficient of elasticity herein referred to is a slope of the straight line portion in the stress-strain diagram showing the relationship between strain and stress, which is obtained employing a tension test meter according to JIS C2318. This slope is called Young's modulus, which is defined in the invention as coefficient of elasticity.

### (Back Coat Layer)

In the printing plate material of the invention, it is preferred that a back coat layer is provided on the surface of the support opposite the image formation layer to be formed. The back coat layer contains a binder, and as the binder, there are a hydrophilic binder and a hydrophobic binder.

The hydrophilic binder may be any as long as it exhibits hydrophilicity, and as examples of the hydrophilic binder, there are resins having, as a hydrophilic group, a hydroxyl group such as polyvinyl alcohol (PVA), cellulose resins (methylcellulose MC, ethylcellulose EC, hydroxyethylcellulose HEC, carboxymethylcellulose CMC), chitins, or starch; resins having an ether bond such as polyethylene oxide PEO, polypropylene oxide PPO, polyethylene glycol PEG, or polyvinyl ether PVE; resins having an amide group or an amide bond such as polyacryl amide PAAM or polyvinyl pyrrolidone PVP.

Further, there are resins having as a dissociation group a carboxyl group such as polyacrylic acid salts, maleic acid resins, alginates or gelatins; polystyrene sulfonic acid salt; resins having an amino group, an imino group, a tertiary amino group or a quaternary ammonium group such as polyallylamine PAA, polyethylene imine PEI, epoxidated polyamide EPAM, polyvinyl pyridine or gelatins.

The hydrophobic binder may be any as long as it exhibits hydrophobicity, and examples of the hydrophobic binder include polymers derived from α,β-ethylenically unsaturated monomers such as polyvinyl chloride, chlorinated polyvinyl chloride, a copolymer of vinyl chloride and vinylidene chloride, a copolymer of vinyl chloride, and vinyl acetate, polyvinyl acetate, partially saponified polyvinyl acetate, polyvinyl acetal or preferably polyvinyl butyral in which a part of polyvinyl alcohol is acetalized with aldehyde, a copolymer of acrylonitrile and acryl amide, polyacrylates, polymethacrylates, polystyrene, polyethylene and a mixture thereof.

It is preferred that the back coat layer contains a matting agent, in order to easily mount the printing plate on a printing press and to prevent “out of color registration” due to “out of registration” of the printing plate during printing.

As the matting agent, a porous or non-porous matting agent or an organic or inorganic matting agent can be used. Examples of the inorganic matting agent include silica, alumina, zirconia, titania, carbon black, graphite, TiO₂, BaSO₄, ZnS, MgCO₃, CaCO₃, ZnO, CaO, WS₂, MOS₂, MgO, SnO₂, Al₂O₃, α-Fe₂O₃, α-FeOOH, SiC, CeO₂, BN, SiN, MoC, BC, WC, titanium carbide, corundum, artificial diamond, garnet, garnet, quartz, silica rock, tripoli, diatomite, and dolomite. Examples of the organic matting agent include polyethylene fine particles, fluororesin particles, guanamine resin particles, acrylic resin particles, silicone resin particles, melamine resin particles, and the like.

As the inorganic material coated fillers, there are, for example, particles in which organic particles such as particles of PMMA or polystyrene as core particles are coated with inorganic particles with a particle size smaller that that of the core particles. The particle size of the inorganic particles is preferably from 1/10 to 1/100 of that of the core particles.

As the inorganic particles, particles of known metal oxides such silica, alumina, titania and zirconia can be used. Various coating methods can be used, but a dry process is preferred which core particles collide with particles for coating at high speed in air as in a hybridizer to push the particles for coating in the core particle surface and fix, whereby the core particles are coated with the particles for coating.

In the invention, when the planographic printing plate material is in the form of roll, the matting agent in the back coat layer is preferably organic resin particles in minimizing scratches on the image formation layer surface.

The average diameter of the matting agent in the invention is determined from equivalent circular diameter obtained from the projected area of the matting agent employing an electron microscope.

The average diameter of the matting agent is preferably from 1 to 12 μm, and more preferably from 2 to 7 μm, in preventing the image formation layer from damaging and in preventing the planographic printing plate material from separating from the plate cylinder of a printing press.

The matting agent content of the back coat layer is preferably from 0.2 to 30% by weight, and more preferably from 1 to 10% by weight.

A laser recording apparatus or a processless printing press has a sensor for controlling transportation of the printing plate material. In the invention, in order to carry out the controlling smoothly, the structural layer preferably contains dyes or pigment. The dyes or pigment are preferably infrared absorbing dyes or pigment as described above used as a light-to-heat conversion material.

### (Planographic Printing Plate Material in Roll Form)

When the planographic printing plate material of the invention is wound and used in the form of roll, it markedly exhibits the effects of the invention.

In the planographic printing plate material in roll form in which a planographic printing plate material in sheet form is wound, the surface on the image formation layer side directly contacts the surface on the back coat layer side.

The planographic printing plate material in roll form may be one in which a long-length planographic printing plate material sheet is wound without a core, but preferably one in which a long-length planographic printing plate material sheet is wound around a core.

### (Imagewise Exposure and Printing)

It is preferred that the planographic printing plate material of the invention is imagewise exposed, employing a thermal head or a laser, and developed on the plate cylinder of a printing press by supplying dampening water or both dampening water and printing ink, followed by printing.

The imagewise exposure is carried out employing preferably a laser, and more preferably a thermal laser.

The imagewise exposure is preferably scanning exposure, which is carried out employing a laser, which can emit light having a wavelength of infrared and/or near-infrared regions, that is, a wavelength of from 700 to 1500 nm.

As the laser, a gas laser can be used, but a semi-conductor laser, which emits light having a near-infrared region wavelength, is preferably used.

A device suitable for the imagewise exposure, which is used in the printing process of the invention, may be any device capable of forming an image on the printing plate material according to image signals from a computer employing a semi-conductor laser.

Generally, the following scanning exposure processes are mentioned.

(1) A process in which a plate precursor provided on a fixed horizontal plate is scanning exposed in two dimensions, employing one or several laser beams.

(2) A process in which the surface of a plate precursor provided along the inner peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

(3) A process in which the surface of a plate precursor provided along the outer peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

In the invention, the process (3) above is preferable, and especially preferable when a printing plate material mounted on a plate cylinder of a printing press is scanning exposed.

### (Printing)

In the invention, a conventional printing process, which employs a dampening solution and printing ink, can be applied.

Employing the printing plate material after imagewise exposure, printing is carried out without a special development process.

That is, the preferred embodiment is a printing process comprising the steps of imagewise exposing the printing plate material of the invention employing a thermal head or a laser, and developing on the plate cylinder of a printing press by supplying dampening water or both of dampening water and printing ink, followed by printing.

After the printing plate material is imagewise exposed and mounted on a plate cylinder of a printing press, or after the printing plate material is mounted on the cylinder and then imagewise exposed, a dampening roller or both of a dampening roller and an inking roller are brought into contact with the image formation layer of the resulting printing plate material while rotating the plate cylinder to remove the image formation layer at non-image portions of the printing plate material.

### EXAMPLES

Next, the present invention will be explained employing examples, but the present invention is not limited thereto. In the examples, “parts” represents “parts by weight”, unless otherwise specified.

### (Preparation of Support)

### (Pet Resin)

Added to 100 parts by weight of dimethyl terephthalate, and 65 parts by weight of ethylene glycol, was 0.05 parts by weight of magnesium acetate anhydrate as an ester exchange catalyst, and an ester exchange reaction was conducted under commonly known practice.

To the obtained product, added were 0.05 parts by weight of antimony trioxide and 0.03 parts by weight of trimethyl phosphate ester.

Subsequently, subjected to a gradual temperature rise and pressure reduction, polymerization was conducted at 280° C. and at 6.65×10 Pa, to obtain polyethylene terephthalate (PET) resin having an intrinsic viscosity of 0.70.

Employing the PET resin as obtained above, biaxially oriented PET film was prepared as described below.

### (Biaxially Oriented Pet Film)

The PET resin was palletized and subjected to vacuum drying at 150° C. for 8 hours. After that, the resin was melt-extruded at 285° C. from a T die to form a layer, and the layer was electrostatically impressed on a 30° C. cooling drum while electrostatically impressed, and cooled to solidification, whereby unoriented film was obtained.

This unoriented film was stretched at a factor of 3.3 in the longitudinal direction, employing a roll type longitudinal stretching machine.

Subsequently, the resulting uniaxially oriented film, using a tenter type transverse stretching machine, was stretched at 90° C. by 50% of the total transverse stretch magnification in the first stretching zone, and then stretched at 100° C. in the second stretching zone so that the total transverse stretch magnification was 3.3.

Further, the resulting film was preheated at 70° C. for two seconds, heat-set at 150° C. for five seconds in the first setting zone and at 220° C. for 15 seconds in the second setting zone.

Thereafter, the film was relaxed at 160° C. by 5% in the transverse (width) direction, passed through the center, cooled to room temperature in 60 seconds, released from the clips, slit and wound around a core to obtain a 175 μm thick biaxially oriented PET film.

The Tg of this biaxially oriented PET film was 79° C., and the thickness distribution of the film was 2%.

The surface on the side of an image formation layer to be formed of the biaxially oriented PET film as obtained above was subjected to corona discharge treatment at 8 W/m²·min. Subsequently, a subbing layer coating solution a-1 described later was coated on the surface of the film on the side of a hydrophilic layer to be formed, and dried at 123° C. to form a subbing layer A-1 with a dry thickness of 0.8 μm on the surface of the film on the hydrophilic layer side.

The surface on the side of the support opposite the subbing layer A was subjected to corona discharge treatment at 8 W/m²·min. Subsequently, a subbing layer coating solution b-1 described later was coated on the resulting surface as a subbing layer for a back coat layer, and dried at 123° C. to form a subbing layer B-1 with a dry thickness of 0.1 μm having anti-static function.

The surface of the subbing layers A-1 and B-1 was subjected to corona discharge treatment at 8 W/m²-min. Subsequently, a subbing layer coating solution a-2 described later was coated on the subbing layer A-1, and dried at 123° C. to form a subbing layer A-2 with a dry thickness of 0.1 μm on the subbing layer A-1, and a subbing layer coating solution b-2 described later was coated on the subbing layer B-1, and dried at 123° C. to form a subbing layer B-2 with a dry thickness of 0.2 μm on the subbing layer B-1. The resulting material was further heat-treated at 140° C. for two minutes. Thus, a subbed support was obtained.

| | | |
|---|---|---|
| (Subbing Layer Coating Solution a-1) | | |
| Latex of styrene/glycidyl methacrylate/butyl acrylate | 250 | g |
| (60/39/1 by mole) copolymer (Tg = 75° C.) | | |
| with a solid content of 30% | | |
| Latex of styrene/glycidyl methacrylate/butyl acrylate | 25 | g |
| (20/40/40 by mole) copolymer (Tg = 20° C.) | | |
| with a solid content of 30% | | |
| Anionic surfactant S-1 (2% by weight) | 30 | g |
| Water was added to make 1 kg. | | |
| (Subbing Layer Coating Solution b-1) | | |
| Metal oxide SnO2 (8.3% by weight) | 109.5 | g |
| Latex of styrene/butyl acrylate/hydroxymethacrylate (27/45/28 | 3.8 | g |
| by mole) copolymer (Tg = 45°) with a solid content of 30% | | |
| Latex of styrene/glycidyl methacrylate/butyl acrylate | 15 | g |
| (20/40/40 by mole) copolymer (Tg = 20°C.) with a | | |
| solid content of 30% | | |
| Anionic surfactant S-1 (2% by weight) | 25 | g |
| Water was added to make 1 kg. | | |
| (Subbing Layer Coating Solution a-2) | | |
| Modified aqueous polyester L-4 solution | 31 | g |
| (with a solid content of 23%) | | |
| Aqueous 5% solution of EXCEVAL (polyvinyl | 58 | g |
| alcohol/ethylene copolymer) RS-2117, | | |
| produced by Kuraray Co., Ltd. | | |
| Anionic surfactant S-1 (2% by weight) | 6 | g |
| Hardener H-1 (0.5% by weight) | 100 | g |
| Spherical silica matting agent SEAHOSTAR KE-P50 | 10 | g |
| (produced by Nippon Shokubai Co., Ltd.) 2% dispersion | | |
| Distilled water was added to make 1000 ml. | | |
| (Subbing Layer Coating Solution b-2) | | |
| Modified aqueous polyester L-3 solution | 150 | g |
| (with a solid content of 18%) | | |
| Anionic surfactant S-1 (2% by weight) | 6 | g |
| Spherical silica matting agent SEAHOSTAR KE-P50 | 10 | g |
| (produced by Nippon Shokubai Co., Ltd.) 2% dispersion | | |
| Distilled water was added to make 1000 ml. | | |

| | |
|---|---|
| | S-1 |
| 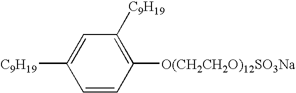 | |
| | H-1 |
| 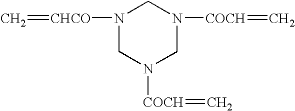 | |

### (Preparation of Aqueous Polyester (L-3) Solution)

A mixture consisting of 35.4 parts by weight of dimethyl terephthalate, 33.63 parts by weight of dimethyl isophthalate, 17.92 parts by weight of sodium salt of dimethyl 5-sulfoisophthalate, 62 parts by weight of ethylene glycol, 0.065 parts by weight of calcium acetate monohydrate, and 0.022 parts by weight of manganese acetate tetrahydrate was subjected to ester exchange reaction at 170 to 220° C. under a flow of nitrogen while distilling out methanol. Thereafter, 0.04 parts by weight of trimethyl phosphate, 0.04 parts by weight of antimony trioxide, and 6.8 parts by weight of 4-cyclohexanedicarboxylic acid were added. The resulting mixture underwent esterification at a reaction temperature of 220 to 235° C. while distilling out a nearly theoretical amount of water.

Thereafter, the reaction system was heated over a period of one hour under reduced pressure, and subjected to polycondensation under a maximum pressure of 133 Pa for 1 hour, while heated to a final temperature of 280° C. Thus, aqueous polyester A-1 was prepared.

The intrinsic viscosity of the resulting polyester A-1 was 0.33.

Subsequently, 850 ml of pure water was placed in a 2-liter three-necked flask fitted with stirring blades, a refluxing cooling pipe, and a thermometer, and 150 g of the aqueous polyester A-1 was gradually added while rotating the stirring blades.

The resulting mixture was stirred at room temperature for 30 minutes, heated to 98° C. over a period of 1.5 hours, and maintained at that resulting temperature for 3 hours, whereby dissolution was performed. Thereafter, the mixture was cooled to room temperature over a period of one hour, and allowed to stand overnight, whereby a 15% by weight aqueous polyester was prepared.

### <<Preparation of Modified Aqueous Polyester L-3 Solution>>

One thousand nine hundred milliliters of the foregoing 15% by weight aqueous polyester were placed in a 3-liter four-necked flask fitted with stirring blades, a reflux cooling pipe, a thermometer and a dripping funnel, and heated to 80° C., while rotating the stirring blades.

Into this added was 6.52 ml of a 24% aqueous ammonium peroxide solution, and a monomer mixture (consisting of 35.7 g of ethyl acrylate and 35.7 g of methyl methacrylate) was dropwise added over a period of 30 minutes, and the mixture was reacted for additional 3 hours.

Thereafter, the reaction mixture was cooled to not more than 30° C., and filtrated. Thus, a modified aqueous polyester L-3 solution having a solid content of 18% by weight was obtained.

### (Preparation of Aqueous Polyester (L-4) Solution)

A mixture consisting of 35.4 parts by weight of dimethyl terephthalate, 33.63 parts by weight of dimethyl isophthalate, 17.92 parts by weight of sodium salt of dimethyl 5-sulfoisophthalate, 62 parts by weight of ethylene glycol, 0.065 parts by weight of calcium acetate monohydrate, and 0.022 parts by weight of manganese acetate tetrahydrate was subjected to ester exchange reaction at 170 to 220° C. under a flow of nitrogen while distilling out methanol. Thereafter, 0.04 parts by weight of trimethyl phosphate, 0.04 parts by weight of antimony trioxide, and 6.8 parts by weight of 4-cyclohexanedicarboxylic acid were added. The resulting mixture underwent esterification at a reaction temperature of 220 to 235° C. while distilling out a nearly theoretical amount of water.

Thereafter, the reaction system was heated over a period of one hour under reduced pressure, and subjected to polycondensation under a maximum pressure of 133 Pa for 1 hour, while heated to a final temperature of 280° C. Thus, aqueous polyester was prepared.

The intrinsic viscosity of the resulting polyester was 0.33 (100 ml/g).

The weight average molecular weight of the resulting polyester was 80,000 to 100,000.

Subsequently, 850 ml of pure water was placed in a 2-liter three-necked flask fitted with stirring blades, a refluxing cooling pipe, and a thermometer, and 150 g of the aqueous polyester A-1 was gradually added while rotating the stirring blades.

The resulting mixture was stirred at room temperature for 30 minutes, heated to 98° C. over a period of 1.5 hours, and maintained at that resulting temperature for 3 hours, whereby dissolution was performed. Thereafter, the mixture was cooled to room temperature over a period of one hour, and allowed to stand overnight, whereby a 15% by weight aqueous polyester Al was prepared.

### <<Preparation of Modified Aqueous Polyester L-4 Solution>>

One thousand nine hundred milliliters of the foregoing 15% by weight aqueous polyester Al were placed in a 3-liter four-necked flask fitted with stirring blades, a reflux cooling pipe, a thermometer and a dripping funnel, and heated to 80° C., while rotating the stirring blades.

Into this added was 6.52 ml of a 24% aqueous ammonium peroxide solution, and a monomer mixture (consisting of 28.5 g of glycidyl methacrylate, 21.4 g of ethyl acrylate and 21.4 g of methyl methacrylate) was dropwise added over a period of 30 minutes, and the mixture was reacted for additional 3 hours.

Thereafter, the reaction mixture was cooled to not more than 30° C., and filtrated. Thus, a modified aqueous polyester B1 solution having a solid content of 18% by weight (vinyl component-modified rate of 20% by weight) was obtained. Further, modified aqueous polyester L-4 having a vinyl component-modified rate of 5% by weight was prepared.

### (Preparation of Back Coat Layer Coating Solution)

A back coat layer coating composition as shown in Table 1 was mixed in a homogenizer while stirring, and filtered to prepare a back coat layer coating solution.

TABLE 1

| | Addition |
|---|---|
| Materials | Amount |
| Colloidal silica: Snowtex-XS | 33.60 g |
| (produced by Nissan Chemical Industries, | |
| Ltd.) with a solid content of 20% | |
| Acryl emulsion: DK-05 (having a solid | 14.00 g |
| content of 48% by weight, produced by | |
| GIFU SHELLAC CO., LTD.) | |
| Matting agent (PMMA with an average | 0.56 g |
| particle size of 5.5 μ) | |
| Pure water | 51.84 g |
| Solid content (% by weight) | 14% |

### (Coating of Back Coat Layer)

The back coat layer coating solution prepared above was coated on the surface (subbing layer surface B) of the subbed support obtained above employing a wire bar #6, and allowed to pass through a 100° C. drying zone with a length of 15 m at a transportation speed of 15 m/minute to form a back coat layer with a coating amount of 2.0 g/m².

### (Preparation of Planographic Printing Plate Material) Preparation of Lower Hydrophilic Layer Coating Solution)

A Lower hydrophilic layer coating composition shown in Table 2 was mixed in a homogenizer while stirring, and filtered to prepare a lower hydrophilic layer coating solution.

TABLE 2

| | Solid | Amount |
|---|---|---|
| Materials | content % | (parts) |
| Porous metal oxide: Silton JC-40 (produced by | 100% | 22.0 |
| Mizusawa Kagaku Co., Ltd.) | | |
| Layer structural clay mineral Montmorillonite: | 5% | 44.0 |
| Mineral Colloid MO gel (porous aluminosilicate | | |
| particles having an average particle size of 4 μm, | | |
| produced by Mizusawa Kagaku Co., Ltd.) | | |
| prepared by vigorously stirring Montmorillonite | | |
| Mineral Colloid MO in water with a homogenizer | | |
| to give a solid content of 5% | | |
| Cu—Fe—Mn type metal oxide black pigment: | 40% | 100.0 |
| TM-3550 black aqueous dispersion (prepared by | | |
| dispersing TM-3550 black powder having a | | |
| particle size of about0.1 μm produced by | | |
| Dainichi Seika Kogyo Co., Ltd. in water to give | | |
| a solid content of 40% (including 0.2% by | | |
| weight of dispersant) | | |
| Carboxymethylcellulose CMC (Reagent produced | 4% | 28.0 |
| by Kanto Kagaku Co., Ltd.) 4% aqueous solution | | |
| Sodium phosphate•dodecahydrate (Reagent | 10% | 5.6 |
| produced by Kanto Kagaku Co., Ltd.) 10% aqueous | | |
| solution | | |
| Colloidal silica: Snowtex-XS (produced by | 20% | 528.2 |
| Nissan Chemical Industries, Ltd.) with a solid | | |
| content of 20% | | |
| Colloidal silica: Snowtex-ZL (produced by | 40% | 17.1 |
| Nissan Chemical Industries, Ltd.) with a solid | | |
| content of 40%) | | |
| Surface-coated melamine resin particles STM- | 100% | 33.0 |
| 6500S (produced by Nissan Chemical Industries, | | |
| Ltd.) with an average particle size 6.5 μm | | |
| REPRESENTS-2117 EXCEVAL (ethylene-vinyl | 5% | 130.0 |
| alcohol copolymer, produced by Kuraray | | |
| Co., Ltd.) | | |
| Silicon surfactant: FZ2161 (produced by Nippon | 20% | 8.8 |
| Unicar Co., Ltd.) with a solid content of 20% | | |
| Pure water | | 83.3 |

### (Preparation of Upper Hydrophilic Layer Coating Solution)

An upper hydrophilic layer coating composition as shown in Table 3 was mixed in a homogenizer while stirring, and filtered to prepare an upper hydrophilic layer coating solution.

TABLE 3

| | Amount |
|---|---|
| Materials | (parts) |
| Colloidal silica (Alkaline): Snowtex-S (produced | 5.2 |
| by Nissan Chemical Industries, Ltd.) with a solid | |
| content of 30% | |
| Necklace colloidal silica (Alkaline): Snowtex-PSM | 11.7 |
| (produced by Nissan Chemical Industries, Ltd.) | |
| with a solid content of 20%) | |
| Colloidal silica (Alkaline): MP-4540 (produced by | 4.5 |
| Nissan Chemical Industries, Ltd.) with a solid | |
| content of 30%) | |
| Porous metal oxide particles: Silton JC-20 | 1.2 |
| (produced by Mizusawa Kagaku Co., Ltd., porous | |
| aluminosilicate particles with an with a an | |
| average particle size of 2 μm) | |
| Porous metal oxide particles: Silton AMT-08 | 3.6 |
| (produced by Mizusawa Kagaku Co., Ltd, porous | |
| aluminosilicate particles with an average particle | |
| size of 0.6 μm) | |
| Layer structural clay mineral Montmorillonite: | 4.8 |
| Mineral Colloid MO gel (porous aluminosilicate | |
| particles having an average particle size of 4 μm, | |
| produced by Mizusawa Kagaku Co., Ltd.) prepared by | |
| vigorously stirring Montmorillonite Mineral | |
| Colloid MO in water with a homogenizer to give a | |
| solid content of 5% | |
| Cu—Fe—Mn type metal oxide black pigment: | 2.7 |
| TM-3550 black aqueous dispersion (prepared by | |
| dispersing TM-3550 black powder having a particle | |
| size of about0.1 μm produced by Dainichi Seika | |
| Kogyo Co., Ltd. in water to give a solid content | |
| of 40% (including 0.2% by weight of dispersant) | |
| Aqueous 10% by weight carboxymethylcellulose | 3.0 |
| sodium salt (produced by Kanto Kagaku Co., Ltd.) | |
| aqueous solution | |
| Sodium phosphate•dodecahydrate (Reagent produced | 0.6 |
| by Kanto Kagaku Co., Ltd.) 10% aqueous solution | |
| Pure water | 62.7 |
| Solid content (% by weight) | 12% |

### (Coating of Lower and Upper Hydrophilic Layer Coating Solutions)

The lower hydrophilic layer coating solution prepared above was coated on the surface (subbing layer surface A) of the support obtained above opposite the back coat layer employing a wire bar #5, and allowed to pass through a 100° C. drying zone with a length of 15 m at a transportation speed of 15 m/minute to form a lower hydrophilic layer.

Subsequently, an upper hydrophilic layer coating solution prepared above was coated on the resulting lower hydrophilic layer employing a wire bar #3, and allowed to pass through a 100° C. drying zone with a length of 30 m at a transportation speed of 15 m/minute to form an upper hydrophilic layer.

The lower hydrophilic layer had a dry coating amount of 3.0 g/m², and the upper hydrophilic layer had a dry coating amount of 0.55 g/m².

The resulting sample was further subjected to aging treatment at 60° C. for one day.

### (Preparation and Coating of Image Formation Layer Coating Solution)

The image formation layer coating solution having a composition as shown in Table 4 was coated onto the above-mentioned upper hydrophilic layer employing a wire bar #5, and allowed to pass through a 70° C. drying zone with a length of 30 m at a transportation speed of 15 m/minute to form an image formation layer.

TABLE 4

| | Amount |
|---|---|
| Materials | (parts) |
| Carnauba wax emulsion: A118 (having an average | 16.0 |
| particle size of 0.3 μm, a melting point of 80° C., | |
| and a solid content of 40%, produced by GIFU | |
| SHELLAC CO., LTD.) | |
| Microcrystalline wax emulsion: A206 (having an | 5.9 |
| average particle size of 0.5 μm and a solid | |
| content of 40%, produced by GIFU SHELLAC CO., | |
| LTD.) | |
| Sodium polyacrylate DL522 (having a molecular | 2.4 |
| weight of 170,000 and a solid content of 30%, | |
| produced by Nippon Shokubai Co., Ltd.) | |
| Pure water | 75.7 |
| Solid content (% by weight) | 9.5% |

The image formation layer had a dry coating amount of 0.5 g/m². The resulting sample was further subjected to aging treatment at 50° C. for 2 days. Thus, a planographic printing plate material sample was prepared.

The resulting planographic printing plate material sample obtained above was cut into a width of 660 mm, and wound 30 m around a paper core having an outer diameter of 76 mm to obtain a planographic printing plate material sample 1

Planographic printing plate material samples 2 through 10 were prepared in the same manner as in planographic printing plate material sample 1, except that the emulsion containing the polymer particles with silica as shown in Table 5 was added in an amount as shown in Table 5 to the upper hydrophilic layer or image formation layer.

In Table 5, the addition amount represents a content (% by weight) in the upper hydrophilic layer or the image formation layer of polymer particles based on the weight of the upper hydrophilic layer or the image formation layer.

### (Evaluation)

### (Printing Method)

Employing a printing press DAIYA 1-F produced by Mitsubishi Jukogyo Co., Ltd, coated paper sheets, dampening water Astromark 3 (produced by Nikken Kagaku Kenkyushosha, 2% by weight), printing ink Toyo TK Hyunity M Magenta (produced by Toyo Ink Manufacturing Co.), printing was carried out, and evaluation of the planographic printing plate material samples was made.

Printing was carried out to print on the other surface of coated paper sheets with a printed image on one surface thereof. When images were printed on a fresh printing paper sheet, powder (Trade name: Nikkalyco M, produced by Nikka Ltd.) was sprayed onto the fresh printing sheet at a printing press powder scale of 5.

### (On-Press Development Property)

Printing was carried out according to the printing conditions described above, and the number of printed copies consumed from when printing started until when a print having an excellent S/N ratio was obtained was determined as a measure of on-press development property. The print having an excellent S/N ratio refers to one in which no background contamination is observed at non-image portions, showing that an image formation layer at non-image portions is completely removed on the press, and image density at image portions is in an appropriate range, and no development defect due to scratches of the image formation layer is observed. The less the number is, the better the on-press development property.

### (Printing Durability)

Printing terminated when either lack of 3% small dots in the image or lowered density at solid image portions was confirmed. The number of printed copies printed until the printing termination was determined as a measure of printing durability.

The results are shown in Table 5. As is apparent from Table 5, inventive planographic printing plate material samples provide excellent on-press development property, and printing durability

TABLE 5

| | | | Image Formation | | | | |
|---|---|---|---|---|---|---|---|
| | Hydrophilic Layer | | Layer | | | | |
| | Emulsion | | Emulsion | | | | |
| | Containing | Addition | Containing | Addition | Developing | Printing | |
| Sample | Polymer | Amount | Polymer | Amount | Property | Durability | |
| No. | Particles | (wt %) | Particles | (wt %) | (Number) | (Number) | Remarks |
| 1 | — | — | — | — | | | Comp. |
| 2 | — | — | ACRYL LX | 50% | | | Comp. |
| 3 | PVA | 20% | — | | | | Comp. |
| 4 | 8055 | 5% | — | | | | Inv. |
| 5 | 8055 | 23% | — | | | | Inv. |
| 6 | 8030 | 5% | — | | | | Inv. |
| 7 | — | — | 8050 | 20% | | | Inv. |
| 8 | — | — | 8303 | 15% | | | Inv. |
| 9 | — | — | 8303 | 70% | | | Inv. |
| 10 | 8030 | 5% | 8303 | 20% | | | Inv. |

PVA: Polyvinyl alcohol (RS-2117 ethylene-vinyl alcohol copolymer, produced by Kuraray Co., Ltd.)
ACRYl LX: Latex of styrene/butyl acrylate/hydroxymethacrylate (27/45/28 by mole) copolymer (Tg = 45° C.)
8055: Mowinyl 8055 (produced by Clariant Polymer Co., Ltd.) (composite of styrene-acryl copolymer and colloidal silica)
8030: Mowinyl 8030 (produced by Clariant Polymer Co., Ltd.) (composite of acryl copolymer and colloidal silica)

1. A planographic printing plate material comprising a plastic support and provided thereon, a hydrophilic layer and an image formation layer, wherein the hydrophilic layer is a layer formed from an emulsion containing polymer particles with silica.

2. A planographic printing plate material comprising a plastic support and provided thereon, a hydrophilic layer and an image formation layer, wherein the image formation layer is a layer formed from an emulsion containing polymer particles with silica.

3. The planographic printing plate material of claim 1, wherein the hydrophilic layer contains polymer particles with silica.

4. The planographic printing plate material of claim 2, wherein the image formation layer contains polymer particles with silica.

5. The planographic printing plate material of claim 3, wherein the hydrophilic layer contains polymer particles with silica in an amount of 0.5 to 30% by weight.

6. The planographic printing plate material of claim 4, wherein the image formation layer contains polymer particles with silica in an amount of 1 to 80% by weight.

7. The planographic printing plate material of claim 1, wherein the image formation layer is a thermosensitive image formation layer.

8. The planographic printing plate material of claim 1, wherein the hydrophilic layer or the image formation layer contains a light-to-heat conversion material.

9. The planographic printing plate material of claim 1, wherein the image formation layer is capable of being subjected to on-press development.

10. The planographic printing plate material of claim 1, wherein the planographic printing plate material is in the roll form.

11. A planographic printing process comprising the step of forming an image on the planographic printing plate material of claim 9, employing a thermal head or a laser, developing the resulting planographic printing plate material on a planographic printing press by supplying dampening water or both of dampening water and printing ink onto the planographic printing plate material, and carrying out printing.
